(19) United States
(12) Patent Application Publication
(10) Pub. No.: US 2002/0124742 A1
(43) Pub. Date: Sep. 12, 2002

(54) Method of printing a textile material in sections

(76) Inventor: Gerold Tebbe, Monte Carlo (MC)

Correspondence Address: FACTOR & PARTNERS, LLC, 1327 W. WASHINGTON BLVD., SUITE 5G/H, CHICAGO, IL, 60607, US

(21) Appl. No.: 10/072,623

(22) Filed: Feb. 8, 2002

(30) Foreign Application Priority Data
Feb. 9, 2001 (DE) 101 06 596.5

(51) Int. Cl. B41M 1/12; B41F 31/00

(52) U.S. Cl. 101/129; 101/491

(57) ABSTRACT

In order to finish a textile material (14) in different sections with different physical and/or chemical properties it is proposed to provide these sections (54, 56, 58, 60, 62) with finishing layers by the rotary screen printing process, each finishing layer having a bonding agent (70)⁶ in which microcapsules (68; 74; 80; 82) are distributed. ⁶(66)?—translator

The invention relates to a method of printing a textile material in sections using at least one printing stencil according to the introductory section of Claim 1.

Known methods of this kind are used to provide neutral textile widths with a monochrome or multicolor pattern.

Also known is a method of finishing textile widths by moving them through a solution of a finishing liquid.

Also known is a method of stitching or welding textile material to a plastics material film which, through sintering of plastics particles or microcracking, is permeable to water vapor but impermeable to water.

The last two above-mentioned methods allow the textile material to be provided with the desired properties only over its full area. In addition, only a limited number of finishing materials can be used.

By means of the present invention a method according to the introductory section of Claim 1 is to be so developed that variable and flexible printing of a textile material, as is known from the multicolor printing of textile widths, is also possible when finishing a textile material, and whereby it is also possible to process inks of higher viscosity.

This object is attained according to the invention by a method with the features specified in Claim 1.

In the method according to the invention use is made of the property of screen printing that a relatively large quantity of ink can be applied per unit of area. In particular, inks containing relatively large particles can also be processed. Because inks of higher viscosity can be applied to the textile material through a screen-printing stencil, a larger number of physical and/or chemical properties of the textile material can be influenced in a targeted way. In some applications in which the controlled physical and/or chemical effect of finishing depends on the mass of material applied, this effect can be intensified with the method according to the invention, or it can only be achieved to an economically interesting degree by the use of this method.

Moreover, the method according to the invention can be implemented with relatively inexpensive printing machines and also in small-batch production (flat screen printing). The fabrication of screen printing stencils is a standard process known to those skilled in the art and is unproblematic.

In addition, if the finishing layer formed by the medium is worn away during use of the textile material, it is advantageous to provide the finishing layer more thickly, as is possible with the method according to the invention.

Advantageous further developments of the invention are the subject matter of the subsidiary claims.

With the method according to Claim 2 an active substance is integrated into the finishing layer, which active substance remains inactive until it is intentionally released by destruction of the wall material of the microcapsules.

The further development of the invention according to Claim 3 enhances the long-term stability of the microcapsules.

The further development of the invention according to Claim 4 enables the microcapsules to bond well with the bonding agent.

An especially good bonding of microcapsule walls and bonding agent is obtained according to Claim 5. In this case even portions of microcapsules projecting somewhat beyond the plane of the finishing layer, and the portions of the finishing layer free of microcapsules, have essentially the same physical and chemical properties. For example, if bonding agent and wall material are selected with a view to having an especially low coefficient of friction with the surface of human skin, this property, which ensures comfort when wearing the textile material against the skin, is obtained uniformly in all areas of the finishing layer.

In the method according to Claim 6 textile materials are produced which in view of various properties of use are particularly suitable for garments.

If the ink bonding agent is selected according to Claim 7 an especially flexible and robust finishing layer is obtained.

The further development of the invention according to Claim 8 ensures that the wall material of the microcapsules has good mechanical stability.

The textile material manufactured with a method according to Claim 9 is distinguished by especially good air permeability, since the matrix film becomes porous when the foaming agent is released as the ink dries. The thickness of the finishing layer can also be increased by this means.

With a method according to Claim 10 it is possible to finish sub-sections of a textile material in different ways.

As a result of a method according to Claim 11 a textile material is obtained which has a different configuration in different areas with regard to its physical and/or chemical properties. Such a modification of physical and/or chemical properties restricted to particular areas is not possible with the conventional finishing process, which always affects the textile width as a whole.

In a method according to Claim 12 a plurality of different physical and/or chemical properties of the textile material can be specified at the same time in a single printing step.

The method according to Claim 13, in which rotary screen printing is used, is especially well suited to large-volume manufacture of textile materials finished with periodic textures.

Such periodic textures in a continuous textile material width are of particular interest if blanks from which garments or suchlike articles are to be produced are to be cut from this textile material in a later processing step. In the method according to Claim 14 the periods of the printed pattern are visual aids, e.g. marks indicating where the textile material width is to be cut or enabling the outlines of a cutting pattern to be correctly aligned to the finished areas of the textile material width.

The further development of the invention according to Claim 15 allows the intensity of the desired physical and/or chemical modification of the textile material to be varied independently of the thickness of the finishing layer by imposing a grid. This is especially advantageous if the finishing layer must have a certain minimum thickness in order to be robust under conditions of extended use.

The grid widths specified in Claim 16 have proved especially appropriate for printing textile materials to be used in garments. Firstly, the pixels are sufficiently large to ensure good mechanical adhesion between finishing layer and textile material. Secondly, these pixels are not so large that local differences in the physical and/or chemical properties of the textile material would be registered on the skin when wearing the garments.

A grid width as specified in Claim 17 is especially suited to the manufacture of finishing layers which are permeable to water vapor but impermeable to water. The particular grid width used depends on the type of textile material.

The grid widths specified in Claim 18 are especially suited to finishing layers by which the wearing properties of a textile material on the skin are to be modified. These are, in particular, finishing layers which cause sliding of a textile material on the skin, the absorption of moisture, the release of skin care agents and the release of anti-perspiration agents or medicaments. A textile material manufactured according to the method according to Claim 18 is also especially suited to the long-term release of certain medicaments for percutaneous administration.

If a finishing layer according to the method specified in Claim 19 is produced, the finishing layer causes only an insignificant change, or no change at all, to the optical appearance of the textile material.

When using a method according to Claim 20 the finishing layer can at the same time form an optical barrier layer. This can be of particular interest for thin materials such as blouse¹ materials. ¹Apparent misprint in original—translator.

The finishing layer produced by the method according to Claim 21 is opaque and white, while a finishing layer produced by the method according to Claim 22 can be intentionally colored so that it either exactly matches the color of the textile material or ensures a desired contrast to this color.

The invention is set forth in more detail below with reference to one embodiment and to the drawings, in which:

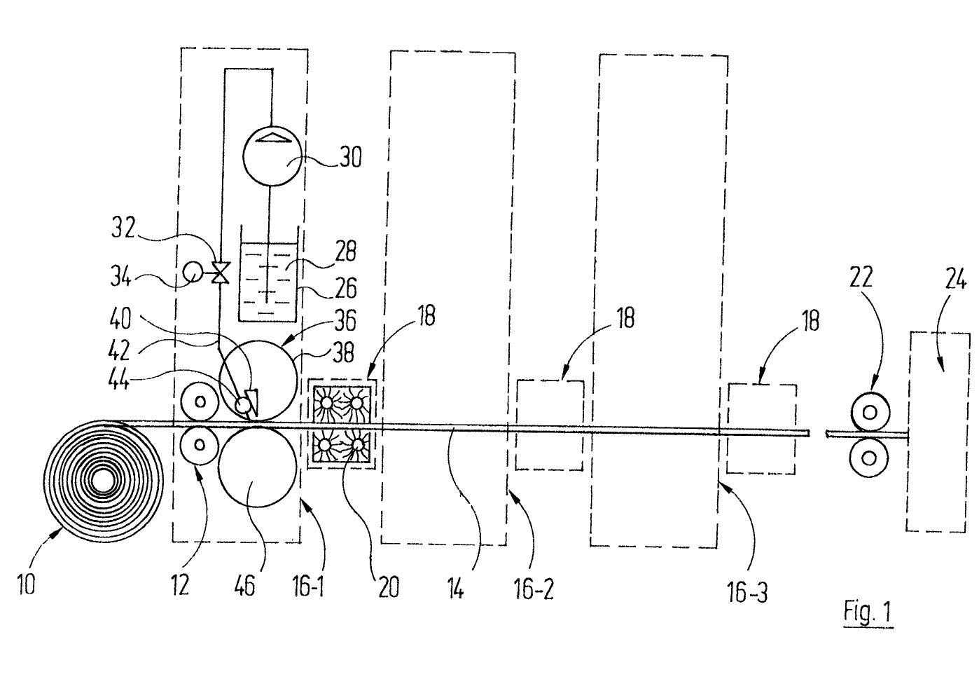

FIG. 1 is a schematic representation of a multi-station rotary screen printing machine used to print a width of textile material; and

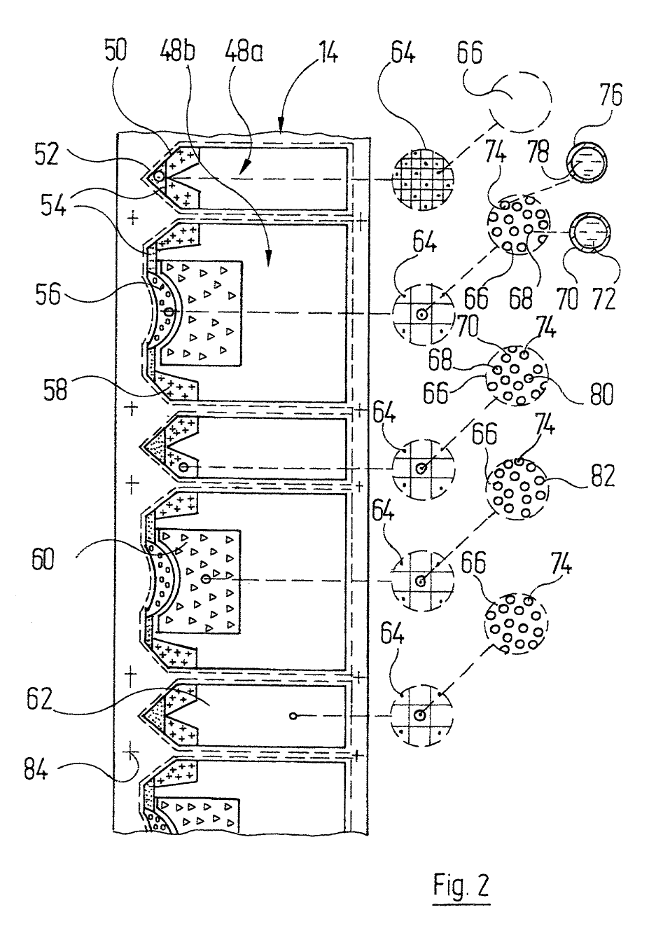

FIG. 2 shows a section of the printed width of textile material.

In FIG. 1 a supply reel from which a textile material width 14 is withdrawn by a pair of conveyor rollers 12 is denoted by 10. The textile material width 14 is generally a woven fabric but other types of textile material can be used, e.g. knitted and fibrous web materials. These various types of textile material can consist of natural fibers, synthetic fibers or mixtures of both these types of fiber. For the purposes of the present description plastics material films and types of paper used for manufacturing garments are included under the term textile material width.

The textile material width 14 is moved through successive different printing stations 16-1, 16-2, 16-3, or generally 16-i, in the feed direction, which stations will be described in detail below. Between each individual printing station is a drying station 18 which, in the embodiment considered here, has radiation bars 20. Depending on the ink used, these may be IR radiation bars, UA² radiation bars or combinations thereof. A hot air drier can also be used in drying stations 18. ²Misprint for UV?—translator.

After the last drying station the textile material width 14 is taken over by a further pair of conveyor rollers 22 which transport the textile material width further to a schematically indicated cutting station 24. Here the printed textile material width 14 is cut into individual sections in a way corresponding to the spacing of the printed pattern applied. In addition, at the same station the sections of material can be cut, either individually or after collection into stacks, into blanks corresponding to parts of a garment, e.g. parts of a pair of trousers, a shirt, a jacket, etc.

In each of the different printing stations 16 an ink is applied to the textile material width 14. For this purpose each printing station has a supply container 26 in which an ink 28 is located. A feed pump 30 sucks the ink from the supply container 26 and feeds it to a metering valve 32, adjusted by a servo motor 34, into the interior of a screen printing drum 36. Said drum has a circumferential wall 38 configured as a screen printing stencil, on the inner side of which runs a squeegee 40, as illustrated. A feed line 42 connected to the outlet of the metering valve 32 is connected to a distributor pipe 44 which is located upstream of the squeegee 40 seen in the direction of rotation of the screen printing drum 38, where it delivers equal quantities of ink across the axial length of the screen printing drum.

Below the screen printing drum 36 is located a counter-drum 46 which has a resilient, soft circumferential surface and is driven synchronously to the screen printing drum 36 in a manner known to those skilled in the art.

FIG. 2 shows a section of the printed textile material width, it being assumed for purposes of explanation that blanks for manufacturing T-shirts are to be produced from the textile material width 14.

The blanks for sleeves and main panels, denoted collectively by 48a and 48b respectively, it being assumed for simplicity that identical blanks are used for the front and back of the T-shirt, have an outer contour 50 which becomes visible through cutting of the textile material width in the cutting station 22 but is not clearly visible on the printed material width. If the cutting line is to be made clearly visible an edge contour 50 and a cutting line 52 closely spaced thereto can be printed on with colored ink in a last printing station 16.

In the area of the blanks 48 various finishing zones can be distinguished, each of which has an edge contour visible in the drawing and is distinguished by small marking patterns: a first finishing zone 54 in what is to be the shoulder area, which has a finishing layer which is water impermeable; a second finishing zone 56 adjacent to the neck-line which is provided with a finishing layer emitting an aromatic agent; a third finishing zone 58 adjacent to the shoulder portions of the finished T-shirt and containing active substances inhibiting perspiration formation and/or perspiration decomposition (this finishing zone can be additionally provided with a deodorant); a further finishing zone 60 corresponding to the back or chest area of the finished T-shirt and provided with a finishing layer containing both moisture absorbing agents and skin-care agents and additionally so configured that it slides easily on the skin surface; and a further finishing zone 62 substantially covering the remainder of the blank, with a finishing layer containing skin-care active ingredients and sliding easily on the skin surface. As illustrated for the finishing zones 54, 56, 58, 60, 62, the different inks forming the finishing layer are applied by screen printing grid. Grid elements printed with ink are marked in the drawing by a dot. The individual grid elements 64 have an edge length which in practice, depending on the type of textile material, is between approx. 0.1 and approx. 10 mm.

In finishing zone 54 where a water-blocking effect is required, the edge length of the grid element is in the range between 0.1 and 0.5 mm. For fine woven materials such as shirt materials an edge length in the range from 0.1 to 0.3 mm is selected. For coarser textile materials, e.g. a thin knitted fabric as used for T-shirts, the edge length of the grid element can be selected in the upper range from approx. 0.3 to 0.5 mm.

The ink used for printing the finishing zone 54 can be a pure silicone ink free of foreign matter (pure matrix layer 66), as can be seen from the further section enlargement. The finishing layer obtained with this ink has good flexibility and blocks water.

Finishing zone 56 has again a printed pattern with grid elements 64 in which, however, the edge length of the grid elements is selected somewhat larger, e.g. in the range between 1 and 3 mm. In this way somewhat larger areas of material located between the grid elements and completely free of ink are obtained. This is desirable with a view to good air permeability of the finished product, although the finishing layer is still felt to be homogeneous by the wearer.

As can be seen from the second section enlargement, the grid elements 64 of finishing layer 56 each have a matrix 66 in which microcapsules 68 are embedded. The matrix consists of a silicone medium; each microcapsule 68 has a wall 70, also consisting of a silicone material, and an active ingredient 72 in which an aromatic substance is enclosed. The material of wall 70 is selected to allow small quantities of the active ingredient 72 (aromatic substance) to pass through the wall as the temperature is raised. The grid elements 64 also contain further microcapsules 74 which have a wall 76 surrounding a skin care oil 78. If the wall 76 is abraded while wearing the T-shirt the skin-care oil 78 is successively released.

The finishing zone 58 again contains grid elements 64, the size of which can be selected similarly to that in finishing zone 56. However, in addition to microcapsules 68 and 74, the bonding agent 66 now contains further microcapsules 80, which contain the active ingredients inhibiting perspiration formation and/or perspiration decomposition.

The similarly structured finishing zone 60 includes microcapsules 74 containing a skin-care oil in the bonding agent 70³, while further microcapsules 82 contain a moisture absorbing material. ³Should be 66?—translator

In the remaining finishing zone 62 the grid elements 64 contain only the microcapsules 74 containing skin-care oil in the bonding agent 66.

In this way the different subdivisions of the blanks 48 and therefore of the T-shirt manufactured from them are finished in different ways, as is desirable in view of the areas of skin surface coming into contact with them.

The zones of the blanks 48 printed with the corresponding inks are only slightly distinguished optically from the textile material width 14. In order to stack the different sections 26⁴ of textile material width correctly for cutting, marks 84 enabling aligned stacking of the material sections are printed on the textile material width 14 in a last printing station 16, which works with a pigmented printing ink; said marks are removed during cutting. ⁴German ‘Abschnitte’ appears to be a typing error—translator.

For other applications modified inks can be used containing different microcapsules which enclose one or more of the following substances: medicaments, nutritional supplements, especially vitamins, and temperature stabilizing materials.

In the embodiment described it was assumed that the same bonding agent is used for all finishing zones. This is desirable with a view to uniform wearing properties throughout the garment. In particular, silicone bonding agents are preferred since they slide easily on the skin.

In a variation of the above-described embodiment an ink can be used the bonding agent of which contains microcapsules enclosing a foaming agent and the walls of which split under the influence of heat. As the ink dries said foaming agent is released. Depending on the type of bonding agent this can cause the agent to form a foam layer which is thick by comparison with the ink layer, or can cause small holes to be formed in the dried ink layer.

However, if special properties which have priority are required in individual finishing zones a different bonding agent can be used in small areas, e.g. in finishing zone 54, in order to ensure special properties therein. This has no influence on the complexity or the cost of the manufacturing process.

1. A method of printing a textile material in sections using at least one printing stencil, whereby the printing stencil is supplied with an ink and the printing stencil supplied with ink is brought into contact with the textile material, characterized in that the printing stencil is a screen printing stencil and in that at least one of the inks contains a bonding agent and an active substance carried by said agent.

2. A method according to claim 1, characterized in that at least one of the active substances is used in microencapsulated form.

3. A method according to claim 2, characterized in that a wall material of the microcapsules is stable with respect to the bonding agent.

4. A method according to claim 3, characterized in that the bonding agent and the wall material of the microcapsules are chemically related.

5. A method according to claim 4, characterized in that the bonding agent and the wall material are formed essentially by the same plastics material.

6. A method according to claim 2, characterized in that the microcapsules enclose one or more of the following substances: moisture absorbing agent, skin-care agent, medicaments, nutritional supplements, in particular vitamins, active substances inhibiting perspiration formation or perspiration decomposition, temperature-stabilizing materials, aromatic substances.

7. A method according to claim 1, characterized in that the bonding agent is a silicone material.

8. A method according to claim 2, characterized in that the wall material of the microcapsules is a silicone material.

9. A method according to claim 1, characterized in that the ink contains a preferably microencapsulated foaming agent, the wall material of the microcapsules being destructible by the action of heat while drying.

10. A method according to claim 1, characterized in that a plurality of successive printing steps is carried out in different sections of the textile material width.

11. A method according to claim 10, characterized in that the individual sections do not overlap.

12. A method according to claim 1, characterized in that the ink comprises a mixture of different active substances.

13. A method according to claim 1, characterized in that a cylindrical circulating screen printing stencil is used.

14. A method according to claim 1, characterized in that the edge contour of a blank is printed on the textile material width.

15. A method according to claim 1, characterized in that the ink is applied in a grid screen printing process.

16. A method according to claim 15, characterized in that grid elements of the screen printing stencil have a dimension of approximately 0.1 to approximately 10 mm.

17. A method according to claim 16, characterized in that the grid elements of the screen printing stencil have a dimension between approximately 0.1 and approximately 1 mm, and preferably between approximately 0.1 and approximately 0.5 mm.

18. A method according to claim 16, characterized in that the grid elements of the screen printing stencil have a dimension between approximately 0.3 mm and approximately 6 mm, and preferably between approximately 1 mm and approximately 3 mm.

19. A method according to claim 1, characterized in that the bonding agent is transparent or translucent.

20. A method according to claim 1, characterized in that the bonding agent is pigmented.

21. A method according to claim 20, characterized in that the pigments are white.

22. A method according to claim 20, characterized in that the pigments are colored.
